(19) United States
(12) Patent Application Publication
(10) Pub. No.: US 2016/0070369 A1
(43) Pub. Date: Mar. 10, 2016

(54) STYLUS STRUCTURE

(71) Applicant: Golden Right Company Ltd., New Taipei City (TW)

(72) Inventor: Te-Hsiang Fang, New Taipei City (TW)

(21) Appl. No.: 14/477,581

(22) Filed: Sep. 4, 2014

(51) Int. Cl. G06F 3/0354

(52) U.S. Cl. CPC G06F 3/03545

(57) ABSTRACT

A stylus structure (100) used to manipulate a touch screen (700) is provided. The stylus structure (100) includes a holding portion (200), an auxiliary touch portion (300), and a flexible connector (500). The holding portion (200) is connected to a conductive core (210). The auxiliary touch portion (300) includes a conductive ring (302) on which a positioning unit (400) is disposed and a throughhole (310) is formed. The flexible connector (500) has one end connected to the conductive core (210) and the other end connected to the conductive ring (302) through the positioning unit (400). The conductive core (210) is formed inside the flexible connector (500) and can touch the touch screen (700). Thus, more precise and smooth manipulation of the touch screen (700) can be obtained.

### BACKGROUND OF THE INVENTION

1. Field of the Invention

The present invention relates to a stylus structure and, in particular, to a stylus structure used to manipulate a capacitive touch screen.

2. Description of Related Art

According to the sensing principle, the touch screens are classified into resistive, capacitive, surface acoustic wave, optics, and electromagnetic types. The resistive touch panel is formed mainly by stacking two ITO conductive layers, the upper and lower electrodes. In operation, pressure is applied to conduct electricity between the upper and lower electrodes. Then, the touch location is calculated based on the change in the panel voltage sensed by the controller. The capacitive touch panel detects the touch coordinates using the capacitance change (induced current) generated by the coupling of electrostatic charges between the transparent electrode and the human body.

Mobile electronic products of Apple company such as iPhone and iPod use the capacitive touch screen. The above products have beautiful appearances and simple, smart operational interfaces; besides, the features of low-reflection, high contrast, endurance, multi-touch, and touch gestures attract customers. Although the capacitance change caused by the electrostatic field between fingers and the touch screen is used to control the capacitive touch screen, the fingers may block the user's sight partially and make it difficult to control the touch location precisely. Also, there may be fingerprints or dirt left on the touch panel.

A capacitive stylus using the combination of a pen tip and a disk is available in the current market. The head of the capacitive stylus has a ball design with a universal joint, which can changes the angle of the head to approach the touch screen. However, the above technical feature which has no buffer design is liable to damage the touch screen or the touch stylus and makes the touch operation awkward. In addition, another kind of stylus is also available in the market, which has a spring connected to the touch portion thereof and thus overcomes the above disadvantages. However, when the user manipulates individual application windows or smaller icons, the issues of deviation and imprecise manipulation will arise. In view of foregoing, the inventor pays special attention to the above existing technology and researches with the application of related theory to overcome the above disadvantages regarding the above related art, which becomes the goal of the inventor's improvement.

### SUMMARY OF THE INVENTION

It is an objective of the present invention to provide a stylus structure which achieves more precise and smooth manipulation of the touch screen.

To achieve the above objective, the present invention provides a stylus structure used to manipulate a touch screen. The stylus structure comprises a holding portion, an auxiliary touch portion, and flexible connector. The holding portion is connected to a conductive core. The auxiliary touch portion comprises a conductive ring on which a positioning unit is disposed and a throughhole is formed. The flexible connector has one end connected to the conductive core and the other end connected to the conductive ring through the positioning unit. The conductive core is formed inside the flexible connector and can touch the touch screen.

Preferably, the positioning unit comprises an annular slot or a plurality of positioning cylinders protruding from the surface of the conductive ring. The annular slot is formed on the edge of an inside wall or the edge of an outside wall of the positioning unit for fixing one end of the flexible connector. A cutaway portion is formed on each of the positioning cylinders for fixing one end of the flexible connector.

Preferably, the holding portion further comprises a conductive bushing sleeved around the first segment of the conductive core. The second segment of the conductive core opposite to the first segment is partly exposed out of the holding portion. One end of the flexible connector is tightly contacted to form a cylindrical spiral which is further positioned to the conductive bushing; the other end of the flexible connector expands gradually to form a conical spiral connected to the conductive ring.

Besides, the present invention has the follow features. One end of the flexible connector expands gradually to form a conical spiral connected to the conductive ring, which enables the user to move the auxiliary touch portion easily with a little force and enables the conductive ring to spring back.

### BRIEF DESCRIPTION OF DRAWING

FIG. 1 is a perspective view of the stylus structure of the present invention;

FIG. 2 shows one embodiment of the stylus structure of the present invention touching the touch screen;

FIG. 3 is a partial cross-sectional view of the stylus structure of the present invention ;

FIG. 4 is a perspective exploded view of the stylus structure of the present invention;

FIG. 5 is a cross-sectional view showing the flexible connector fixed to the positioning unit;

FIG. 6 is another cross-sectional view showing the flexible connector fixed to the positioning unit;.

FIG. 7 is a cross-sectional view showing an annular inclined surface disposed on the conductive ring;

FIG. 8 is a perspective exploded view of the flexible connector and positioning unit according to the third embodiment of the present invention, before assembly; and

FIG. 9 is a partial perspective view of FIG. 8.

### DETAILED DESCRIPTION OF THE INVENTION

The detailed description and technical details of the present invention will be explained below with reference to accompanying figures. However, the accompanying figures are only for reference and explanation, but not to limit the scope of the present invention.

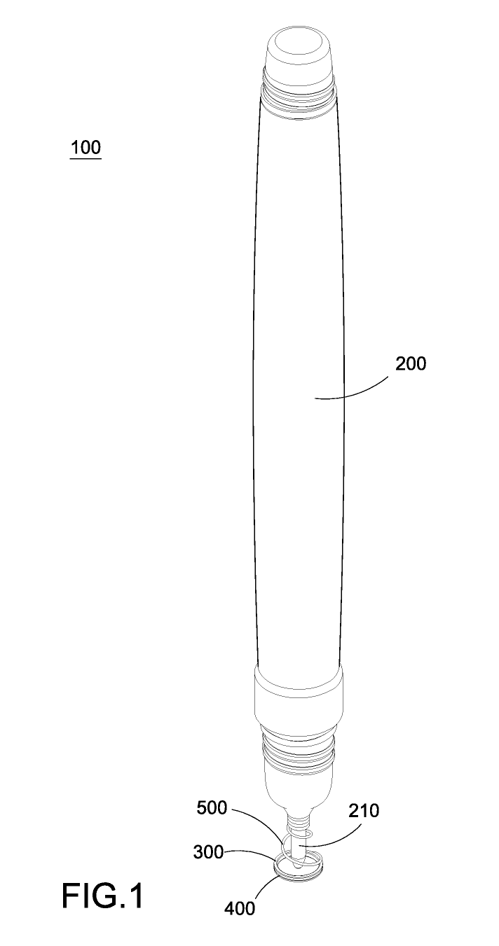

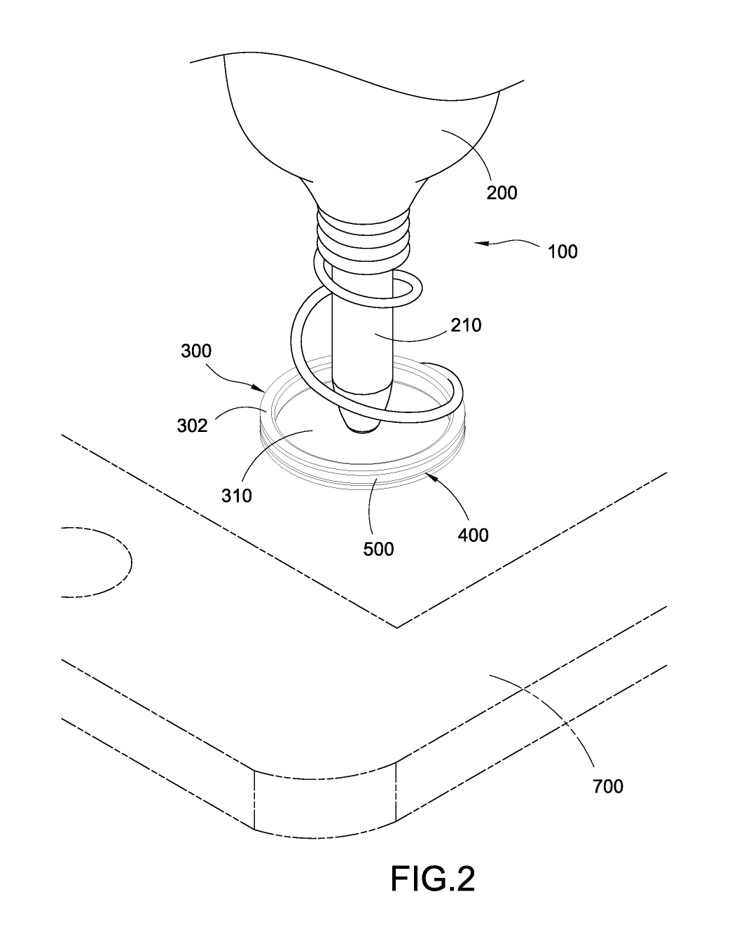

As shown in FIGS. 1-4, the present invention provides a stylus structure 100 used to manipulate a capacitive touch screen 700 (as shown in FIG. 2). The capacitive touch screen 700 mentioned here includes, but not limited to, the smartphone, tablet computer, and other similar products. The stylus structure 100 comprises a holding portion 200, an auxiliary touch portion 300, and a flexible connector 500. The holding portion 200 is connected to a conductive core 210.

The auxiliary touch portion 300 comprises a conductive ring 302 on which a positioning unit 400 is disposed and a throughhole 310 is formed. The conductive core 210 is formed inside the flexible connector 500 and can touch the touch screen 700. In the current embodiment, the conductive ring 302 is, but not limited to, a transparent ring adhered with an electrically conductive film (not shown), a copper with a smooth surface or other proper metal material. In general, the outer diameter of the conductive ring 302 is around 8 mm; the diameter of the throughhole 310 is around 4 mm, but not limited to these.

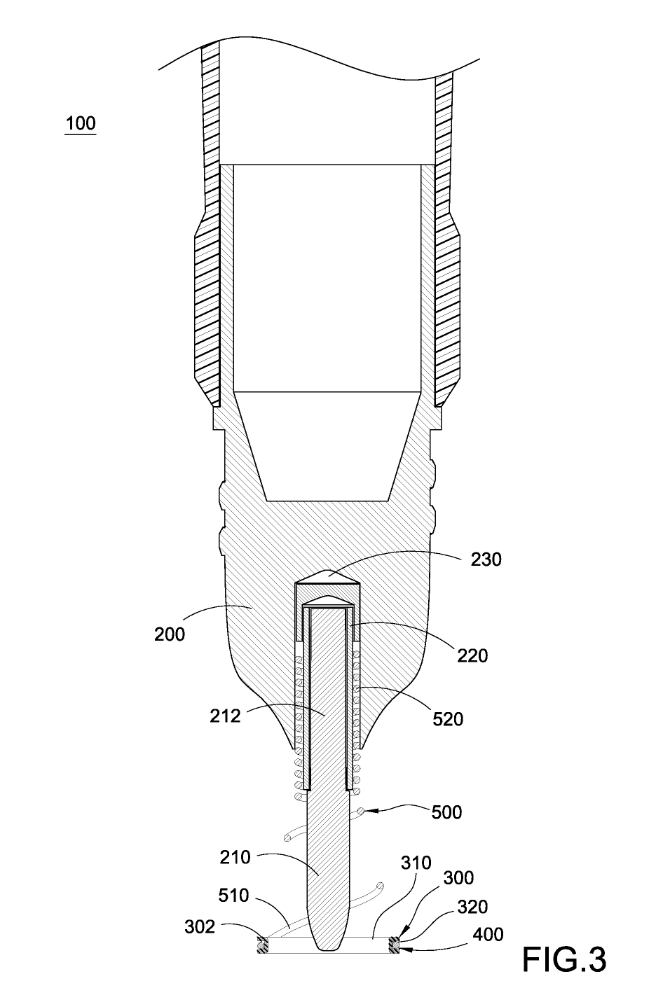

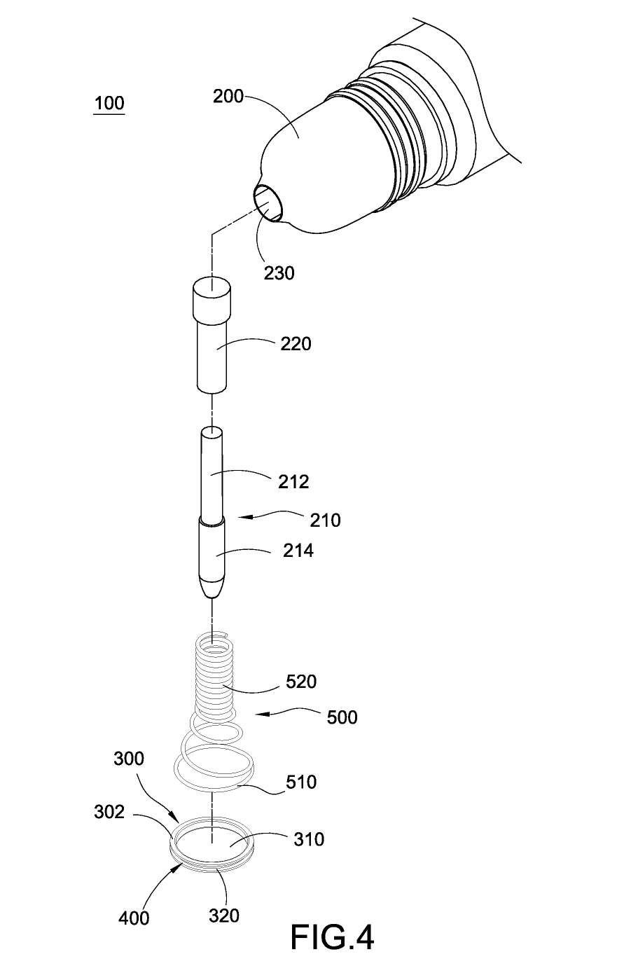

Besides, the flexible connector 500 is preferably a helical spring made of a material with better electrical conductivity such as silver, copper, aluminum, or alloy thereof. As shown in FIGS. 3 and 4, one end of the flexible connector 500 expands gradually to form a conical spiral 510 connected to the conductive ring 302 of the auxiliary touch portion 300; the other end of the flexible connector 500 is tightly contacted to form a cylindrical spiral 520 connected to one end of the conductive core 210. The gradually expanding conical spiral 510 mentioned here means each coil of the conical spiral 510 does not tightly contact to each other in contrast to the cylindrical spiral 520 and is a spiral form with an increasing space between two adjacent coils. Also, the cone angle of the conical spiral 510 is not limited. When the user simply applies a little force, the conical spiral 510 can be made to move the auxiliary touch portion 300. Also, the auxiliary touch portion 300 has an effect of spring back. Therefore, when the conductive core 210 passes through the throughhole 310 of the auxiliary touch portion 300 and touches the touch screen 700, the flexible connector 500 exhibits better elastic flexibility such that the flexible connector 500 can move flexibly with respect to the conductive core 210.

In the embodiment shown in FIGS. 3 and 4, the holding portion 200 further comprises a conductive bushing 220 and a hole 230. The conductive bushing 220 is sleeved around one end of the conductive core 210. Then, one end of the flexible connector 500 (i.e., the cylindrical spiral 520) is positioned on the conductive bushing 220. Because the conductive core 210 is made of elastic material, such as conductive fiber, conductive rubber, or other proper material, the conductive core 210 is sleeved by the conductive bushing 220 to prevent damage. As shown in FIG. 4, because the diameter of one end of the conductive bushing 220 is equal to the inner diameter of the hole 230 and the nesting of the flexible connector 500, the conductive bushing 220, and the conductive core 210 has a diameter roughly equal to the inner diameter of the hole 230. Thus, the flexible connector 500, the conductive bushing 220, and the conductive core 210 can be assembled and accepted in the hole 230.

In the current embodiment, the conductive core 210 further comprises a first segment 212 and a second segment 214 having a diameter larger than that of the first segment 212. The second segment 214 is partly exposed out of the holding portion 200; the first segment 212 is sleeved by the conductive bushing 220. The conductive bushing 220 is substantially positioned between the first segment 212 and the second segment 214 such that the conductive bushing 220 cannot move further toward the second segment 214. Therefore, the cylindrical spiral 520, fixed to the conductive bushing 220, of the flexible connector 500 does not easily move toward the auxiliary touch portion 300 on the conductive bushing 220. Besides, the cylindrical spiral 520 and the conical spiral 510 of the flexible connector 500 in the current embodiment are separated substantially from the joint of the first segment 212 and the second segment 214.

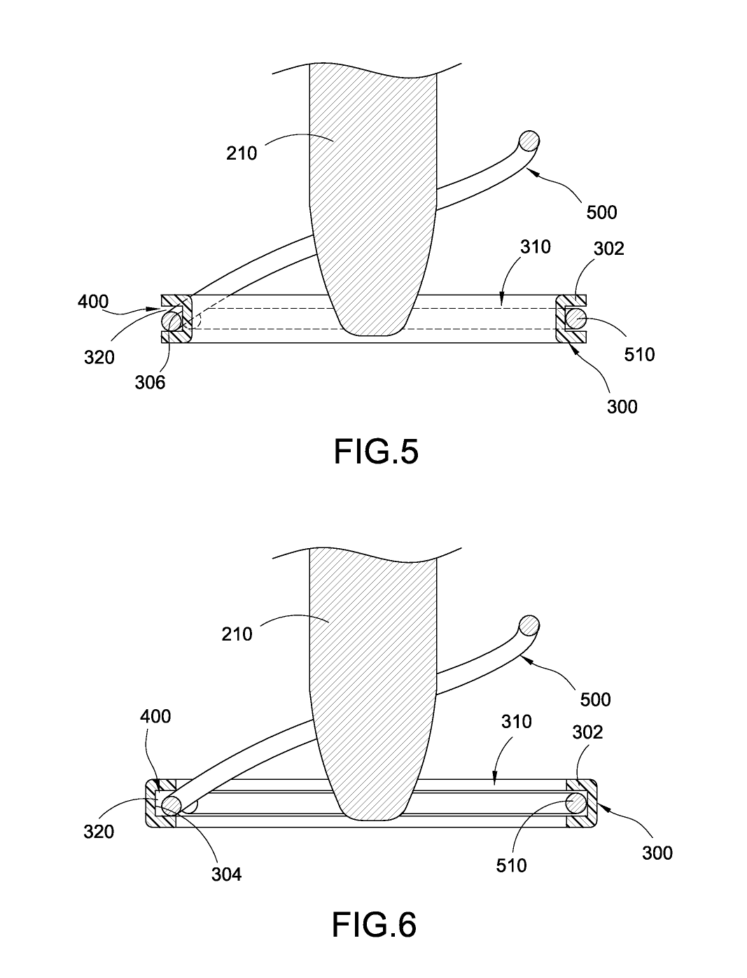

How the flexible connector 500 is connected to the auxiliary touch portion 300 through the positioning unit 400 is further explained as follows. Please also refer to FIG. 5, the positioning unit 400 further comprises an annular slot 320 which is formed on the edge of an outside wall 306 of the positioning unit 400 for fixing one end of the flexible connector 500 (i.e., the conical spiral 510). However, in the embodiment shown in FIG. 6, the annular slot 320 can also be formed on the edge of an inside wall 304 of the positioning unit 400. In the embodiments of FIGS. 5 and 6, the size of the annular slot 320 is preferably larger than or equal to the wire diameter of flexible connector 500. In this way, the flexible connector 500 can be positioned in the annular slot 320 by its own spring rigidity.

Therefore, after the conductive ring 302 of the auxiliary touch portion 300 touches the touch screen (not shown), the conductive core 210 passes through the throughhole 310 of the auxiliary touch portion 300 to touch the touch screen 700 and the conductive ring 302 can move smoothly and flexibly following the conductive core 210. That is to say, the auxiliary touch portion 300 touches the touch screen first and provides approximate targeted point/object and then the conductive core 210 pinpoints the targeted point/object more precisely. Finally, electronic signals are formed by the conductive ring 302 touching the touch screen and then transferred into the coordinates. Consequently, when the user manipulates individual application windows or smaller icons, the stylus structure 100 of the present invention can manipulate the touch screen (not shown) more precisely and smoothly.

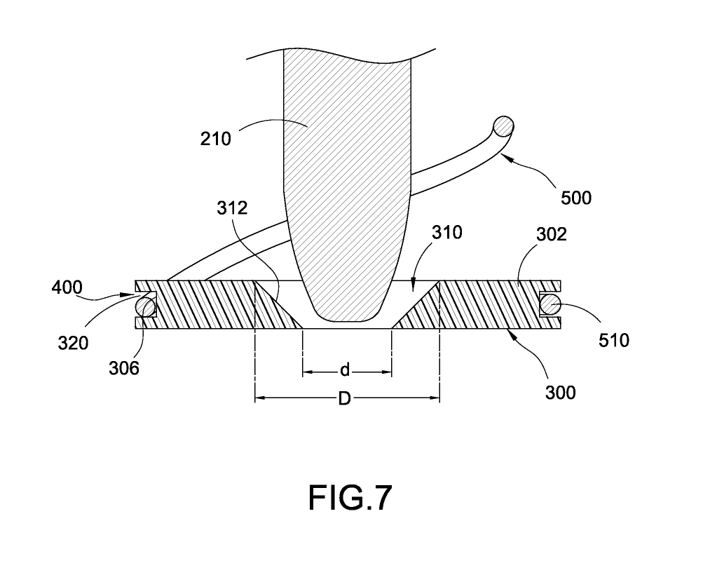

To align the targeted point/object more precisely and rapidly, the conductive ring 302 further comprises an annular inclined surface 312, as shown in FIG. 7. The annular inclined surface 312 is disposed on the inner wall of the throughhole 310 to form a first inner diameter d and a second inner diameter D larger than the first inner diameter d such that the distance between the first inner diameter d and the holding portion 200 is larger than that between the second inner diameter D and the holding portion 200. The size of the first inner diameter d is roughly larger than the outer diameter of the conductive core 210, which enables the conductive core 210 to pass through the first inner diameter d. Because the size of the throughhole 310 of the conductive ring 302 is smaller than that in the previous embodiment, the relative displacement of conductive ring 302 and the conductive core 210 becomes smaller; therefore, the conductive core 210 can align the targeted point/object more precisely and rapidly. In addition, the annular inclined surface 312 (at an angle of 90°, but not limited to this) of the conductive ring 302 has functions of guiding and aligning the conductive core 210.

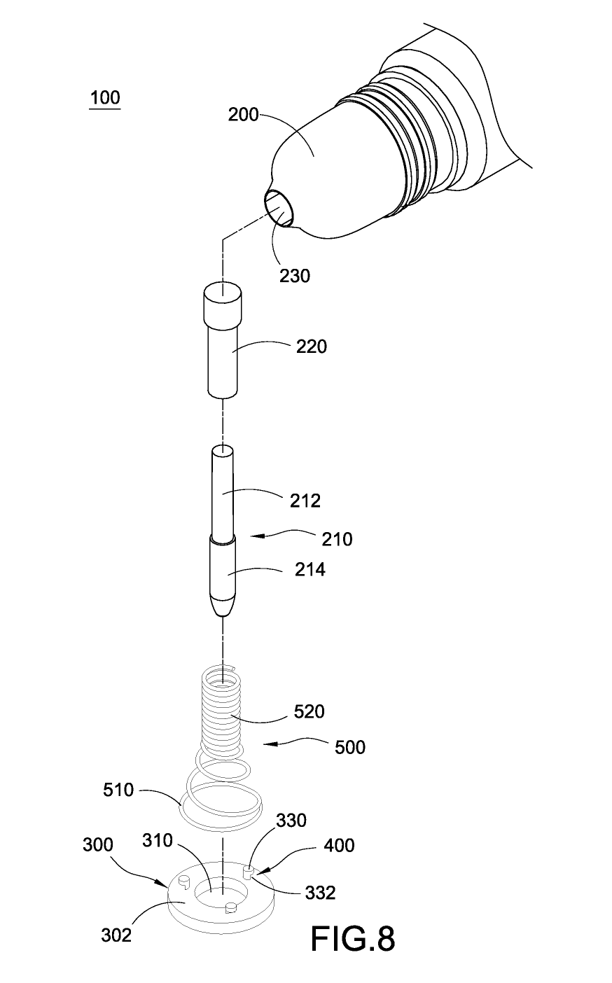

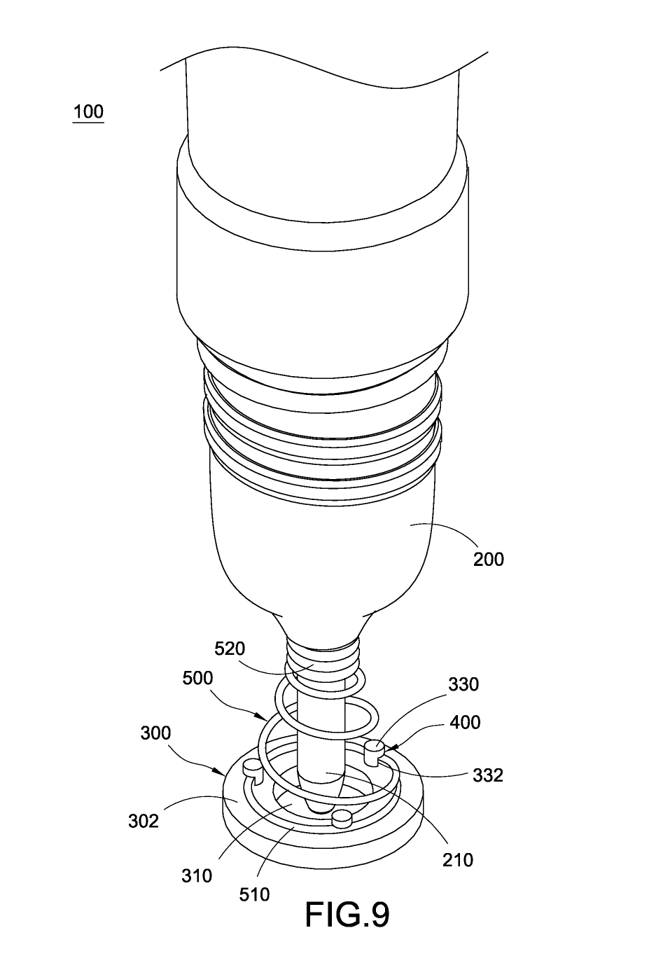

FIGS. 8 and 9 are perspective exploded view before assembly and partial perspective view after assembly, respectively, of the flexible connector and positioning unit according to the third embodiment of the present invention. The positioning unit 400 further comprises a plurality of positioning cylinders 330 protruding from the surface of the conductive ring 302. A cutaway portion 332 is formed on each of the positioning cylinders 330 for fixing one end of the flexible connector 500. In the current embodiment, the positioning unit 400 preferably has three positioning cylinders 330. In another embodiment, two positioning cylinders 330 can also achieve the same function. Similarly, after the conductive ring 302 of the auxiliary touch portion 300 touches the touch screen (not shown), the conductive core 210 passes through the throughhole 310 to touch the touch screen 700 and the conductive ring 302 can move smoothly and flexibly following the conductive core 210. In this way, smooth and precise manipulation of various buttons or smaller objects on the touch screen can be obtained.

The embodiments disclosed herein are used to explain the present invention, but not to limit the present invention. The scope of the present invention should be defined by the accompanying claims and embraces the legal equivalents, but not limited to the above description.

What is claimed is:

1. A stylus structure (100) used to manipulate a touch screen (700), the stylus structure (100) comprising:
a holding portion (200) connected to a conductive core (210);
an auxiliary touch portion (300) comprising a conductive ring (302) on which a positioning unit (400) is disposed and a throughhole (310) is formed; and
a flexible connector (500) with one end connected to the conductive core (210) and the other end connected to the conductive ring (302) through the positioning unit (400), wherein the conductive core (210) is formed inside the flexible connector (500) and can touch the touch screen (700).

2. The stylus structure (100) according to claim 1, wherein the positioning unit (400) further comprises an annular slot (320) which is formed on the edge of an inside wall (304) or the edge of an outside wall (306) of the positioning unit (400) for fixing one end of the flexible connector (500).

3. The stylus structure (100) according to claim 1, wherein one end of the flexible connector (500) expands gradually to form a conical spiral (510) connected to the conductive ring (302), wherein the other end of the flexible connector (500) is tightly contacted to form a cylindrical spiral (520) connected to the conductive core (210).

4. The stylus structure (100) according to claim 1, wherein the flexible connector (500) is an electrically conductive helical spring.

5. The stylus structure (100) according to claim 1, wherein the holding portion (200) further comprises a conductive bushing (220) sleeved around one end of the conductive core (210), wherein one end of the flexible connector (500) is further positioned on the conductive bushing (220).

6. The stylus structure (100) according to claim 5, wherein the conductive core (210) further comprises a first segment (212) and a second segment (214) having a diameter larger than that of the first segment (212), wherein the second segment (214) is partly exposed out of the holding portion (200), wherein the first segment (212) is sleeved by the conductive bushing (220).

7. The stylus structure (100) according to claim 5, wherein the holding portion (200) further has a hole (230) with an inner diameter equal to a diameter of one end of the conductive bushing (220) to assemble and accept the conductive bushing (220) in the hole (230).

8. The stylus structure (100) according to claim 7, wherein the nesting of the flexible connector (500), the conductive bushing (220), and the conductive core (210) has a diameter equal to the inner diameter of the hole (230) such that the flexible connector (500), the conductive bushing (220), and the conductive core (210) can be assembled and accepted in the hole (230).

9. The stylus structure (100) according to claim 1, wherein the conductive ring (302) further comprises an annular inclined surface (312) which is disposed on the inner wall of the throughhole (310) and forms a first inner diameter (d) and a second inner diameter (D) larger than the first inner diameter (d) such that the distance between the first inner diameter (d) and the holding portion (200) is larger than that between the second inner diameter (D) and the holding portion (200).

10. The stylus structure (100) according to claim 1, wherein the conductive ring (302) is a transparent ring adhered with an electrically conductive film or a copper material with a smooth surface.
